(19) United States
(12) Patent Application Publication
(10) Pub. No.: US 2023/0306741 A1
(43) Pub. Date: Sep. 28, 2023

(54) PRODUCT DETECTION DEVICE, PRODUCT DETECTION METHOD, AND RECORDING MEDIUM

(71) Applicant: NEC Corporation, Minato-ku, Tokyo (JP)

(72) Inventors: Rina Tomita, Tokyo (JP); Yuji Tahara, Tokyo (JP)

(73) Assignee: NEC Corporation, Minato-ku, Tokyo (JP)

(21) Appl. No.: 18/018,802

(22) PCT Filed: Jul. 31, 2020
(86) PCT No.: PCT/JP2020/029490

§ 371 Date: Jan. 30, 2023

(51) Int. Cl. G06V 20/50; G06V 10/70; G06V 10/46; G06V 10/74

(52) U.S. Cl. CPC G06V 20/50; G06V 10/87; G06V 10/46; G06V 10/74; G06Q 10/087

(57) ABSTRACT

A product detection device is provided with an image acquisition unit, a determination unit, a selection unit, and a detection unit. The image acquisition unit acquires an image of a shelf on which products are displayed. The determination unit determines, from the image, product display information including at least one of a shape of shelf, shapes of the products, and a display condition. The selection unit selects, on the basis of the determined product display information, a model to be used to detect the image. The detection unit uses the selected model to detect the state of the display of the products displayed on the shelf from the image.

### TECHNICAL FIELD

The present disclosure relates to a product detection device, a product detection system, a product detection method, and a product detection program.

### BACKGROUND ART

Currently, the problem of difficulties in securing store employees due to labor shortage is becoming more serious. In such an environment, it is desired to develop a technique for saving labor such as product inventory management and work of replenishing products on a display shelf, and reducing the burden on employees.

In a store, there is known a method of detecting stockout and display disturbance of products displayed on a product shelf or the like by using a learned model (hereinafter, also referred to as a model) obtained by learning an image of a displayed product.

PTL 1 discloses a technique of capturing an image of a state of a product shelf and superimposing and displaying images color-coded according to a display state in such a way that a display shortage state can be recognized. PTL 2 describes a technique for making notification so as to replenish the products when there are few products on the product shelf and performing reordering for inventory storage.

### CITATION LIST

### Patent Literature

[PTL 1] JP 2016-58105 A
[PTL 2] JP 2010-517148 A

### SUMMARY OF INVENTION

### Technical Problem

However, PTL 1 and PTL 2 do not disclose a technique for improving accuracy of detecting stockout or display disturbance of the product in each store. It is necessary to set a detection condition for each store when stockout and display disturbance of products displayed on the product shelf are detected. For example, between stores, the shelf to be used may be different, or the display position, the orientation of display of the product, and the mode of display of the product may be different even when the shelf is the same. Therefore, when a model learned at one place is used, false recognition is likely to occur in detection of a product in respective stores, and detection accuracy is degraded.

In order to solve the above problems, an object of the present disclosure is to provide a technique for improving detection accuracy by using a model suitable for a display state in a store.

### Solution to Problem

A product detection device according to an aspect of the present disclosure includes
an image acquisition unit that acquires an image of a shelf on which a product is displayed,
a determination unit that determines, from the image, product display information including at least one of a shape of the shelf, a shape of the product, or a condition of the display,
a selection unit that selects a model to be used for detecting the image based on the determined product display information, and
a detection unit that detects, from the image, a display state of the product displayed on the shelf by using the selected model.

A product detection system according to an aspect of the present disclosure includes
the product detection device described above,
a camera that captures the image to transmit the image to the product detection device, and
a terminal that receives a notification related to the detection from the product detection device.

A product detection method according to an aspect of the present disclosure includes
acquiring an image of a shelf on which a product is displayed,
determining, from the image, product display information including at least one of a shape of the shelf, a shape of the product, or a condition of the display,
selecting a model to be used for detecting the image based on the determined product display information, and
detecting, from the image, a display state of the product displayed on the shelf by using the selected model.

A recording medium storing a product detection program according to an aspect of the present disclosure causes a computer to execute
acquiring an image of a shelf on which a product is displayed,
determining, from the image, product display information including at least one of a shape of the shelf, a shape of the product, or a condition of the display,
selecting a model to be used for detecting the image based on the determined product display information, and
detecting, from the image, a display state of the product displayed on the shelf by using the selected model.

The program may be stored in a non-transitory computer-readable recording medium.

Any combinations of the above components and modifications of the expressions of the present disclosure among methods, devices, systems, recording media, computer programs, and the like are also effective as aspects of the present disclosure.

Various components of the present disclosure do not necessarily need to be individually independent. A plurality of components may be formed as one member, one component may be formed of a plurality of members, a certain component may be part of another component, part of a certain component may overlap with part of another component, and the like.

Although the method and the computer program of the present disclosure describe a plurality of procedures in order, the order of description does not limit the order in which the plurality of procedures is executed. Therefore, when the method and the computer program of the present disclosure are implemented, the order of the plurality of procedures can be changed within a range in which there is no problem in content.

Furthermore, the plurality of procedures of the method and the computer program of the present disclosure is not limited to the method and the computer program being executed at individually different timings. Therefore, another procedure may occur during execution of a certain procedure. The execution timing of a certain procedure and the execution timing of another procedure may partially or entirely overlap with each other.

### Advantageous Effects of Invention

An effect of the present disclosure is to provide a technique for improving detection accuracy by using a model suitable for a display state in a store.

### BRIEF DESCRIPTION OF DRAWINGS

FIG. 1 is a diagram conceptually illustrating a configuration example of a product detection system according to the first example embodiment of the present disclosure.

FIG. 2 is a diagram illustrating an internal configuration example of a product detection device according to the first example embodiment of the present disclosure.

FIG. 3 is a diagram illustrating an example of a data structure of image information.

FIG. 4 is a diagram illustrating an example of a data structure of shelf information.

FIG. 5 is a diagram illustrating an example of a data structure of product information.

FIG. 6 is a view illustrating an example of a shelf image on a product shelf.

FIG. 7 is a view illustrating an example of a shelf image on a product shelf.

FIG. 8 is a diagram illustrating an internal configuration example of a store terminal.

FIG. 9 is a flowchart illustrating an operation example of the product detection device according to the first example embodiment of the present disclosure.

FIG. 10 is a diagram illustrating a configuration example of a product detection system according to the second example embodiment of the present disclosure.

FIG. 11 is a diagram illustrating an example of a data structure of product information.

FIG. 12 is a diagram illustrating an example of shelf images and conversion tables different in a placement manner.

FIG. 13 is a diagram illustrating an example of shelf images and conversion tables different in a stacking manner.

FIG. 14 is a flowchart illustrating an operation example of the product detection device according to the second example embodiment of the present disclosure.

FIG. 15 is a diagram illustrating a configuration example of a product detection device according to the third example embodiment of the present disclosure.

FIG. 16 is a block diagram illustrating a hardware configuration example of a computer that implements each device of the product detection system.

### EXAMPLE EMBODIMENTS

Hereinafter, exemplary embodiments of the present disclosure will be described with reference to the drawings. In all the drawings, the same components are denoted by the same reference numerals, and the description thereof will be omitted as appropriate. In the following drawings, configurations of portions not involved in the essence of the present disclosure are omitted and not illustrated.

In the example embodiment, “acquiring” includes at least one of a case where the host acquire data or information stored in another device or a recording medium (active acquisition), and a case where data or information output from another device is input to the host device (passive acquisition). Examples of the active acquisition include requesting or inquiring another device and receiving a reply thereto, and accessing another device or a recording medium and reading data. Examples of passive acquisition include receiving information to be distributed (alternatively, transmitted, push notified, and the like). Further, “acquiring” may include selecting and acquiring data or information from among received data or information, or selecting and receiving distributed data or information.

### First Example Embodiment

### (Commodity Detection System)

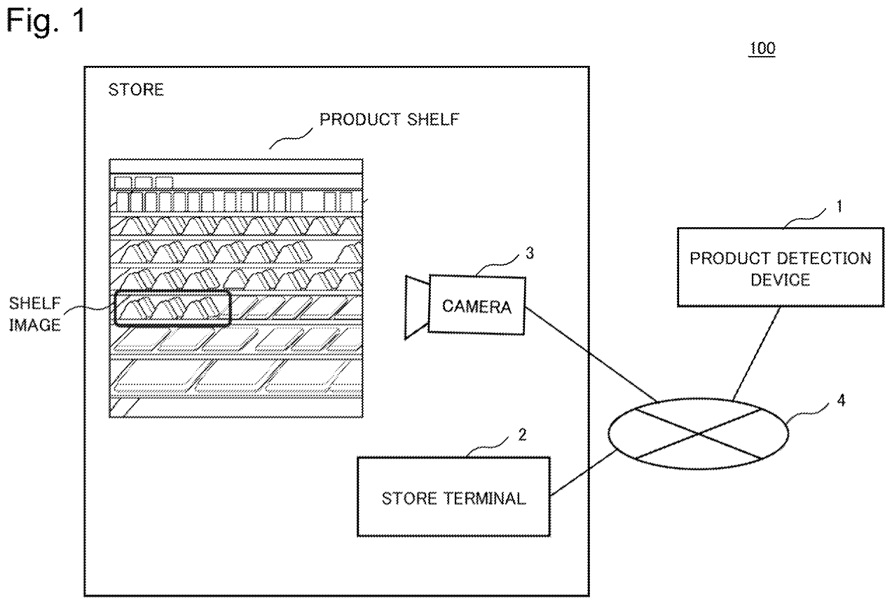

FIG. 1 is a block diagram conceptually illustrating a configuration example of a product detection system 100 according to the first example embodiment of the present disclosure. The product detection system 100 includes a product detection device 1, a store terminal 2, and a camera 3. The camera 3 and the store terminal 2 are connected to product detection device 1 via a communication network 4 such as the internet or an intranet. Note that the product detection device 1 may be provided in a store and connected to the camera 3 by a wired cable or the like.

Camera 3 is a camera that is provided for each store and captures an image of a product shelf. The camera 3 may be a camera provided with a fisheye lens for photographing a wide area. The camera 3 may be a camera including a mechanism (for example, a mechanism that moves on a rail installed on a ceiling) that moves in the store. There may be a plurality of cameras 3, and each camera 3 captures a shelf image that is a section of the product shelf.

The image of the product shelf captured by the camera is transmitted to the product detection device 1, and the product detection device 1 detects stockout or display disturbance of the product. When stockout or display disturbance of the product of the product is detected, the product detection device 1 notifies the store terminal 2 of a detection result. The store terminal 2 presents, to a store clerk, information for correcting stockout or display disturbance of the product.

### (Commodity Detection Device)

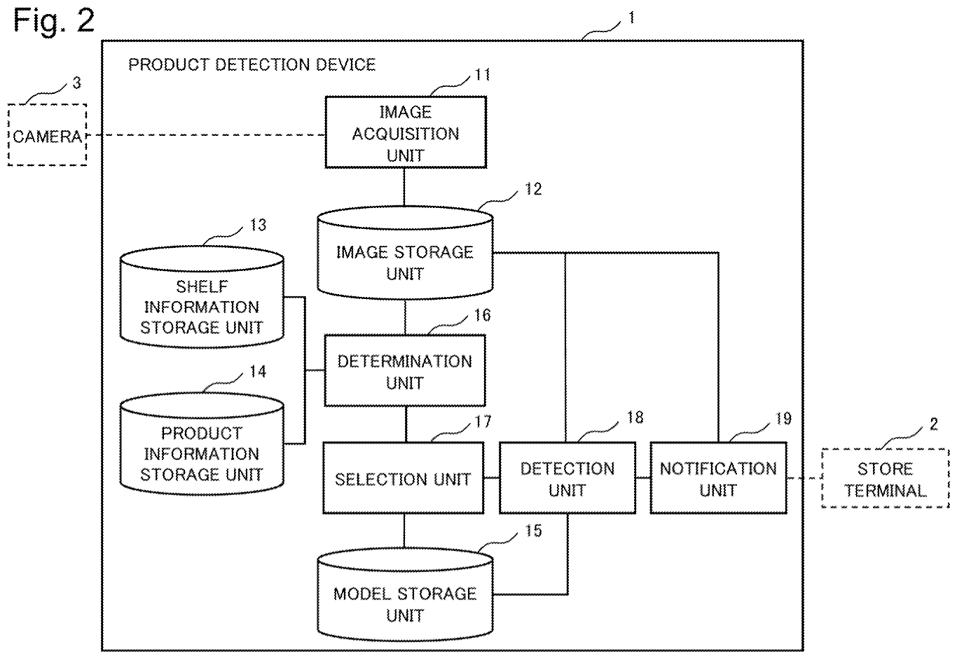

Next, an example of an internal structure of the product detection device 1 will be described with reference to FIG. 2.

The product detection device 1 includes an image acquisition unit 11, an image storage unit 12, a shelf information storage unit 13, a product information storage unit 14, a model storage unit 15, a determination unit 16, a selection unit 17, a detection unit 18, and a notification unit 19.

The image acquisition unit 11 acquires a shelf image, which is a section of a product shelf on which a product is displayed, imaged by the camera 3. A product and a background (such as a shelf) appear in the image. The image acquisition unit 11 stores the acquired image in the image storage unit 12 together with information about the image (hereinafter, also described as image information).

The image storage unit 12 stores the image and the image information acquired from the image acquisition unit 11.

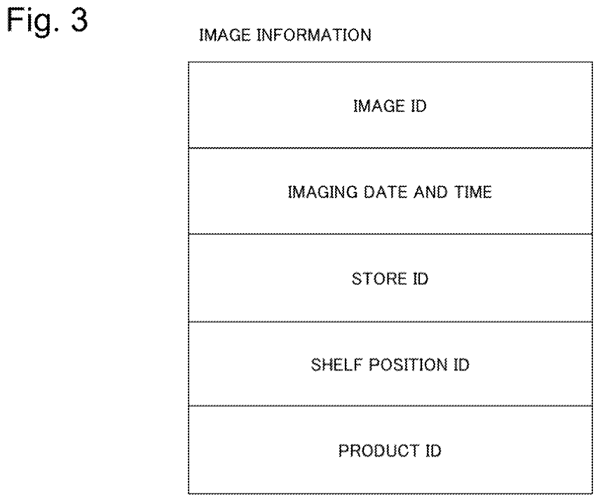

The image information will be described with reference to FIG. 3. The image information includes, for example, an image identifier (ID), an imaging date and time, a store ID, a shelf position ID, and a product ID.

The image ID is an identifier for uniquely identifying an image. For example, it may be sequential numbers in the imaging order. When there is a plurality of cameras 3, a camera ID for uniquely identifying the camera may be assigned to the image ID. For example, in the case of the 100th image captured by the camera A, “image ID: A-100” is set.

The imaging date and time is a date and time when the camera 3 imaged the shelf image. A time stamp function provided in the camera 3 may be available to the date and time. Since the imaging date and time of the image can be determined, it is possible to select a shelf image of the latest imaging date and time or extract a shelf image imaged in a specific date and time or period.

The store ID is an identifier that can uniquely identify the store where the image is captured.

The shelf position ID is an identifier for identifying the position of the image in the store. For example, it is assumed that there are 10 shelves (shelf number 1-10) in a certain store A, and the shelves are classified into sections 1-5. In such a case, the store ID and the shelf position ID indicating the image of the section 3 with shelf number 5 are, for example, “A (store)-5 (shelf)-3 (section)”.

The product ID is an identifier for identifying the product appearing in the image. In the acquisition of the product ID of the product appearing in a certain shelf image, what product is displayed at the corresponding shelf position may be assigned in advance as information, or information (for example, a product code) about a product tag assigned to the front face of the shelf in the image may be read by the image acquisition unit 11 and automatically input. Alternatively, an image recognition engine may be mounted on the camera 3 or the product detection device 1, and the product and the product ID thereof may be identified by an image recognition process. Note that a plurality of products may appear in one image. For example, when a can juice A (product ID: KA) and a can juice B (product ID: KB) appear in an image, two product IDs of KA and KB are assigned as product IDs.

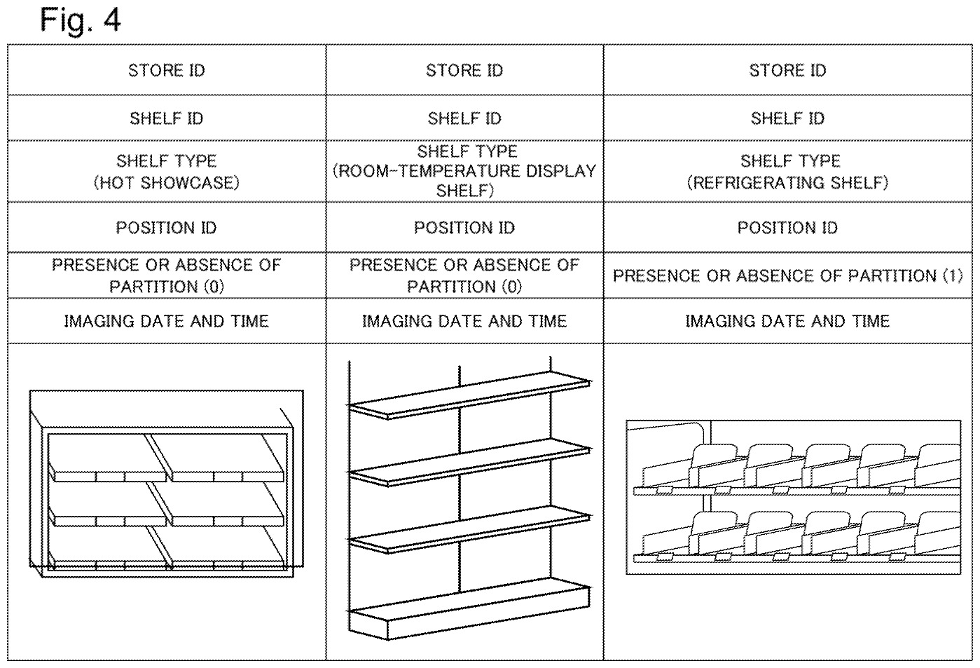

The shelf information storage unit 13 stores shelf information. The shelf information is obtained by associating an image of a product shelf acquired in advance from the camera 3 with information about the product shelf. For example, as illustrated in FIG. 4, the shelf information includes a store ID, a shelf ID, a shelf type, a position ID, presence or absence of a partition, an imaging date and time, and a shelf image.

The store ID is an identifier for uniquely identifying a store. It may be a store name.

The shelf ID is an identifier for uniquely identifying the shelf.

The position ID is an identifier for identifying the position of the shelf image in the store. For example, it is assumed that there are 10 shelves (shelf number 1-10) in a store, and each shelf is divided into 5 sections (section 1-5). In the case of the shelf image of the section 3 of the shelf number 1, the position ID is 1 (shelf number)-3 (position number).

The shelf type is information indicating a type of a shelf. Examples thereof include a hot showcase, a room-temperature display shelf, and a refrigerating shelf.

The presence or absence of a partition is information indicating whether there is a partition mechanism (for example, a partition, a rail, or the like) for partitioning products or there is no partition mechanism (only a flat face). As a specific example, as to the presence or absence of the partition, “1” is input when there is a partition, and “0” is input when there is no partition.

The imaging date and time is a date and time when the camera 3 imaged the shelf image. The imaging date and time may be acquired using a time stamp function of the camera 3.

The shelf image is an image of a display shelf.

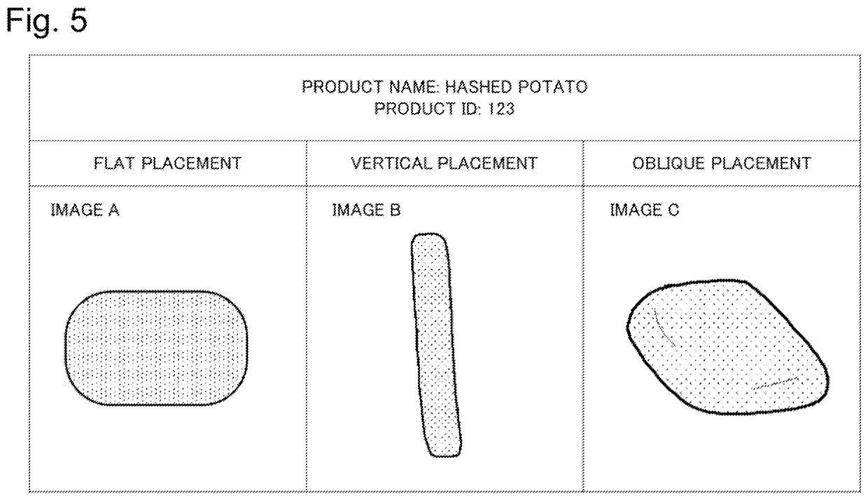

The product information storage unit 14 stores product information in which a certain product image and product image information are associated with each other. For example, as illustrated in FIG. 5, the product image information includes a product name, a product ID, an orientation, and a product image.

The product name is a name of a product (for example, hashed potato). The product ID is an identifier for uniquely identifying a product. The orientation is an arrangement shape (for example, flat placement, vertical placement, and oblique placement) of products imaged from a plurality of angles. There may be many types of arrangement shapes.

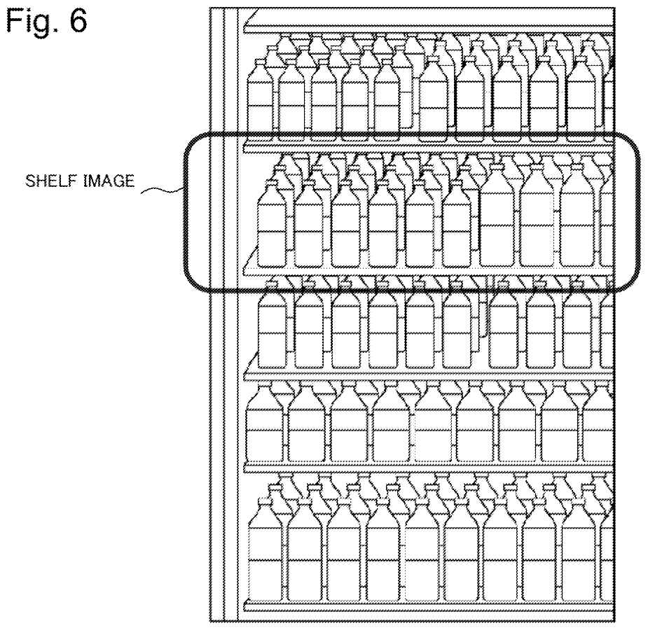

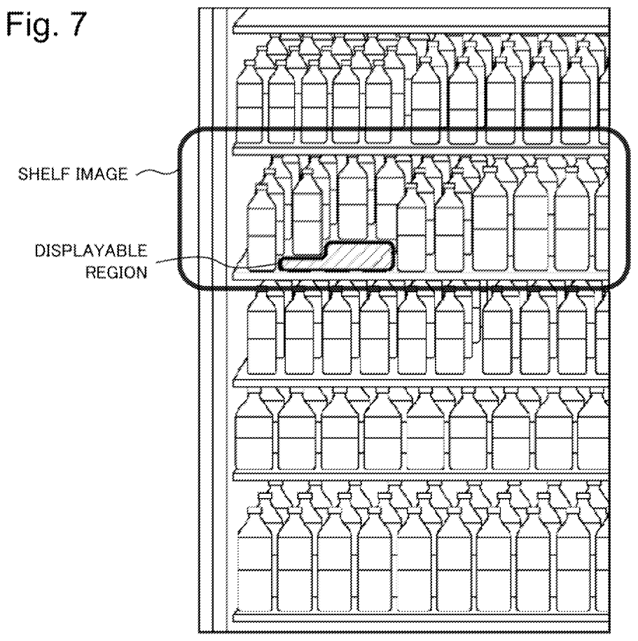

The model storage unit 15 stores a model learned for each of the shape of the product shelf, the shape of the product, and the condition of the display. The model estimates the number of products from the image and estimates the display disturbance from the image. The model includes a first model and a second model. The first model is a model that has learned a difference (first difference) between a displayable region in which products on the shelf stand included in a first image captured at a first time are allowed to be displayed and a displayable region of the shelf stand included in a second image captured at a second time after the first time. For example, FIGS. 6 and 7 show shelf images of product PET bottles on a product shelf. There is no displayable region in the shelf image imaged at the first time illustrated in FIG. 6, but a displayable region is generated in the shelf image imaged at the second time after a predetermined period has elapsed (see FIG. 7). This is a display state in which the inventory quantity of the product is reduced. The first model detects a region (area, position, and the like in the displayable region in FIG. 7) that is the first difference. The second model calculates a difference (second difference) between the inventory quantity at the imaging date and time of the shelf image of FIG. 6 and the inventory quantity at the imaging date and time of the shelf image of FIG. 7 in the product PET bottle based on the image information. For example, when the inventory quantity in FIG. 6 is 50 and the inventory quantity in FIG. 7 is 45, the second difference (number) related to the first difference (region) in the product PET bottle is detected as 5. Note that, in the case of the display disturbance of the product, the model can determine the display disturbance according to the shape of the displayable region in FIG. 7. In FIG. 7, the displayable region is a region in which the upper side of the back side of the shelf and the lower side of the front side of the shelf are parallel, and no disturbance of display occurs. However, for example, in a case where the shape of the displayable region is irregularly a circle or an ellipse, or in a case where the frame line of the displayable region is an irregular curve, the model determines that display disturbance occurs.

The determination unit 16 determines product display information including at least one of a shape of a shelf, a shape of a product, or a condition of the display from an image captured by the camera 3 for detection. The determination is made by using, for example, an image recognition engine (a pattern recognition model such as a support vector machine) by machine learning.

The shape of the shelf is, for example, a type of the product shelf or a shape of the product shelf (the number of display stages, a shape of a display stage, etc.). The determination unit 16 compares the image of the shelf in the image with the shelf information (see FIG. 4) stored in the shelf information storage unit 13 to determine the shape of the shelf.

The shape of the product is, for example, a shape for each orientation of the product (flat placement shape, vertical placement shape, and oblique placement shape). The determination unit 16 compares the image of the product in the image with the product information (see FIG. 5) stored in the product information storage unit 14 to determine the shape of the product.

The condition of the display is, for example, a condition in which products are disposed in a row along a partition, or a condition in which products are randomly disposed on a display stand. The condition of the display may be determined by the presence or absence of a partition for product display. The determination unit 16 may determine the condition based on whether there is a partition in the shelf information (see FIG. 4) of the shelf determined to match in the shelf shape. Note that the determination unit 16 may determine the condition of the display using an image recognition engine.

The selection unit 17 selects a model to be used for image detection based on the product display information (information including at least one of a shape of a shelf, a shape of a product, or a condition of the display) determined by the determination unit 16. For example, assuming that the shape of the product shelf has a 3 patterns, the shape of the product has a 3 patterns, and the condition of the display has a 2 patterns, 18 models are stored in the model storage unit 15. The selection unit 17 selects a model matching the result of the determination by the determination unit 16 from the model storage unit 15. The selection unit 17 notifies the detection unit 18 of the selected model.

The detection unit 18 detects a display state (for example, a normal state, a stockout state, and a display disturbance state) of products displayed on the shelf from the image by using the model selected by the selection unit 17. As described above, for a certain product, the first model detects a first difference between a displayable region, in a first image of a shelf on which the products are displayed, in which the products are allowed to be displayed and the displayable region in a second image acquired after acquisition of the first image. Next, for the certain product, the second model calculates the first difference and a second difference that is a difference between the number of products appearing in the first image and the number of products appearing in the second image, and detects stockout of the product or display disturbance of the product using the calculation result. The detection unit 18 detects an anomaly (for example, product stockout, display disturbance) in the display state of the product by using the model. A value (for example, “5” in the case of a product PET bottle) by which it is determined that there is an anomaly (replenishment of products is necessary) of stockout of each product is set in the detection unit 18. When detecting the anomaly in the display state of the product, the detection unit 18 notifies the notification unit 19 of the detection result. For example, when six product PET bottles disappear (are purchased) from the product shelf, it notifies the notification unit 19 of the detection result.

Upon receiving a notification from the detection unit 18 that an anomaly (for example, product stockout, display disturbance) in the display state of the product has been detected, the notification unit 19 notifies the store terminal 2 of a result of the detection.

### (Store Terminal)

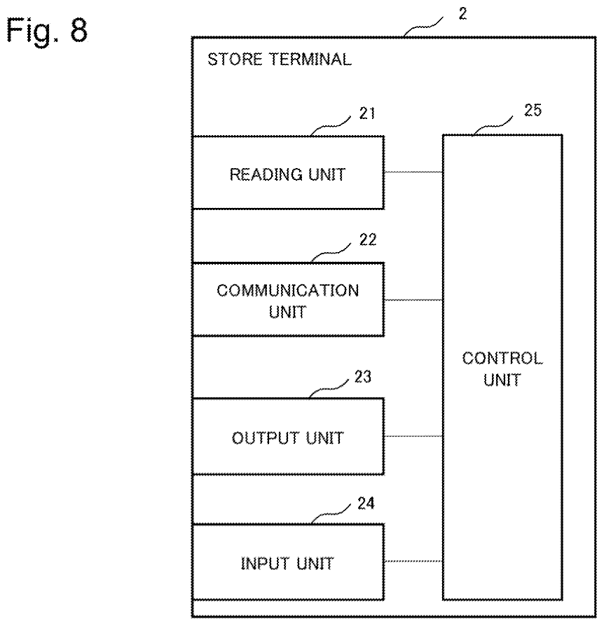

Next, the store terminal 2 will be described with reference to FIG. 8. The store terminal 2 is a terminal used by a store clerk for product management and the like. The store terminal 2 includes, for example, a reading unit 21, a communication unit 22, an output unit 23, an input unit 24, and a control unit 25.

The reading unit 21 reads product information (such as a barcode). The communication unit 22 performs communication between the store terminal 2 and an external device (for example, the product detection device 1 and a POS terminal (not illustrated)).

Output unit 23 displays the information read by the reading unit 21 and the information (for example, the detection result) received from the external device (the notification unit 19 of the product detection device 1) on a display (not illustrated).

The input unit 24 is a keyboard, a touch panel, or the like for a store clerk to input information to the store terminal 2.

The control unit 25 is connected to the reading unit 21, the communication unit 22, the output unit 23, and the input unit 24, and controls operations of these units.

### (Operation of Product Detection Device)

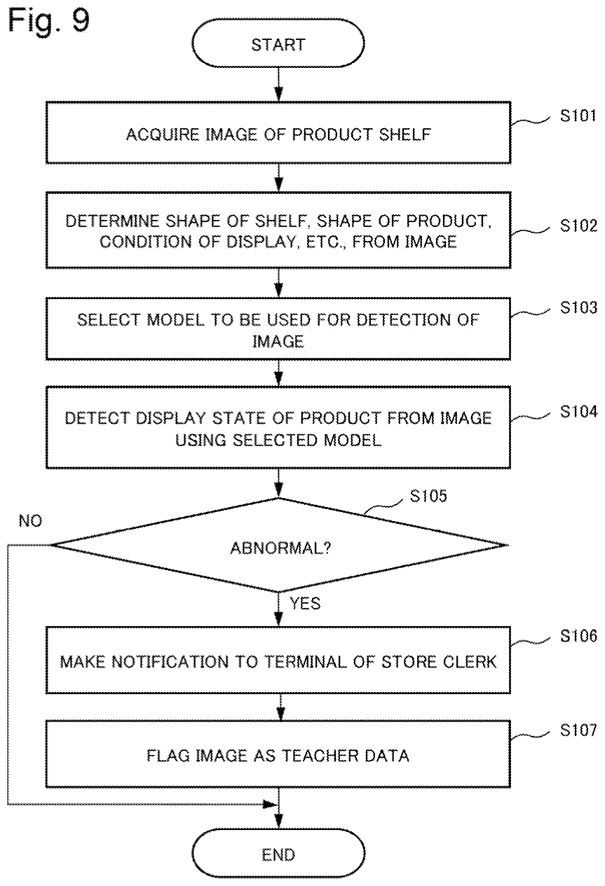

An operation of the product detection device 1 in the product detection system 100 will be described with reference to a flowchart illustrated in FIG. 9. As a premise, the shelf information is stored in the shelf information storage unit 13, the product information is stored in the product information storage unit 14, and a model is stored in the model storage unit 15.

First, in step S101, the image acquisition unit 11 acquires a shelf image, which is one section of the product shelf imaged by the camera 3, to store the shelf image in the image storage unit 12. Specifically, the image acquisition unit 11 generates image information about the shelf image, and stores the shelf image and the generated image information in association with each other in the image storage unit 12.

In step S102, the determination unit 16 determines, from the shelf image, the product display information including at least one of the shape of the shelf, the shape of the product, or the condition of the display. Specifically, the determination unit 16 acquires the shelf image from the image storage unit 12, and determines the shape of the shelf included in the shelf image, the shape of the product included in the shelf image, and the condition of the display of the product. The determination unit 16 transmits the determined information to the selection unit 17.

In step S103, the selection unit 17 selects a model to be used for detecting the shelf image based on the product display information determined by the determination unit 16. Specifically, the selection unit 17 selects a model to be used for detecting the shelf image from among a plurality of models included in the model storage unit 15 based on the product display information determined by the determination unit 16. The selection unit 17 notifies the detection unit 18 of the selected model.

In step S104, the detection unit 18 detects the display state of the product on the shelf from the shelf image using the model selected by the selection unit 17. Specifically, the detection unit 18 detects an anomaly (for example, product stockout, display disturbance) in the display of the product included in the shelf image by using the model. When an anomaly is detected (YES in step S105), the detection unit 18 transmits a detection result (for example, the occurrence of product stockout and the occurrence of display disturbance) to the notification unit 19, and the process proceeds to step S106. When no anomaly is detected (NO in step S105), this process ends.

In step S106, the notification unit 19 transmits the detection result to the store terminal 2.

In step S107, the notification unit 19 flags the shelf image in the image storage unit 12. This is because the shelf image in which the anomaly is detected can be extracted later. The notification unit 19 may add an index to the shelf image in the image storage unit 12. The flagged shelf image is used as teacher data for causing the model to relearn (feed back).

As described above, the operation of product detection device 1 in product detection system 100 is ended.

### Effects of First Example Embodiment

According to the first example embodiment of the present disclosure, it is possible to improve detection accuracy by using a model suitable for a display state of a product in a store. This is because the image acquisition unit 11 acquires an image of a shelf on which a product is displayed, the determination unit 16 determines product display information including at least one of a shape of the shelf, a shape of the product, or a condition of the display, the selection unit 17 selects a model to be used for detecting the image based on the determined product display information, and the detection unit 18 detects a display state of the product displayed on the shelf from the image using the selected model.

### Second Example Embodiment

In the first example embodiment of the present disclosure, it is assumed that the product is placed flat (without stacking) on the shelf stand. However, in stores, products may be stacked in order to effectively utilize the space. Therefore, in the second example embodiment, a method for detecting an anomaly of the product in a shape of products in consideration of the stacked state including the shape of the products placed on one stage and the shape of the products placed on a plurality of stages in a stacking manner will be described.

### (Commodity Detection System)

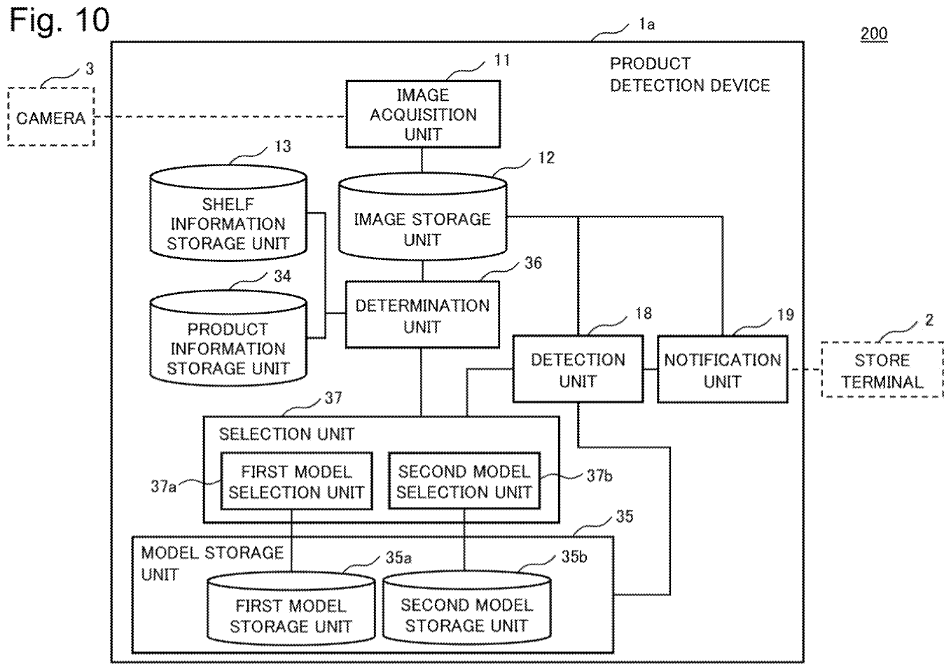

FIG. 10 is a block diagram conceptually illustrating a configuration example of a product detection system 200 according to the second example embodiment of the present disclosure. The product detection system 200 includes a product detection device 1a, the store terminal 2, and the camera 3.

The product detection device 1a includes the image acquisition unit 11, the image storage unit 12, the shelf information storage unit 13, a product information storage unit 34, a model storage unit 35, a determination unit 36, a selection unit 37, the detection unit 18, and the notification unit 19.

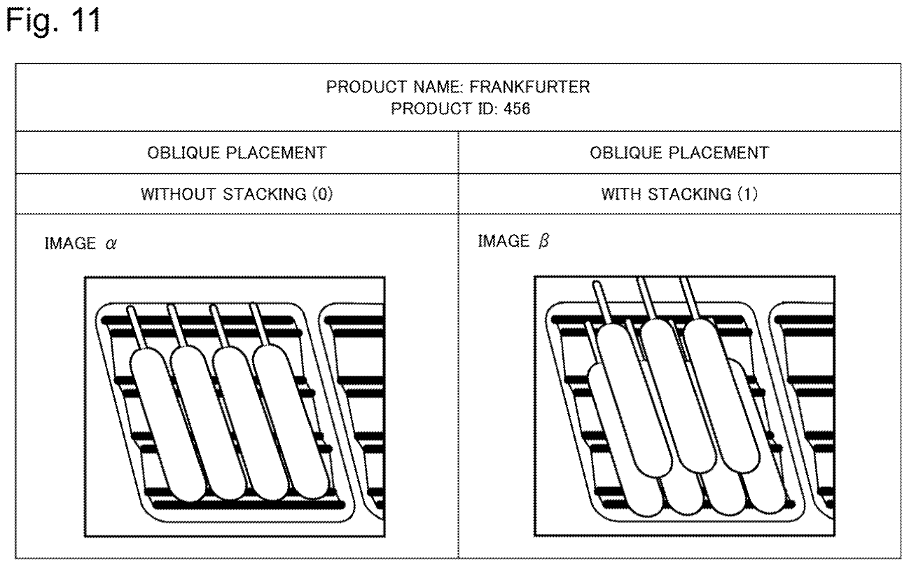

The product information storage unit 34 stores product information. The product information according to the second example embodiment will be described with reference to FIG. 11. The product information of the second example embodiment includes, for example, a product name, a product ID, an orientation, presence or absence of stacking, and a product image.

The product name is a name of a product (for example, a frankfurter). The product ID is an identifier for uniquely identifying a product. The orientation is an arrangement shape (for example, obliquely placing) of the products imaged from a plurality of angles.

The presence or absence of stacking is information for determining a state of stacking (a shape of products placed on one stage and a shape of products placed on a plurality of stages in a stacking manner in a shape of the product). Specifically, the presence or absence of stacking is information indicating whether to be stacked and displayed in a plurality of stages, and is represented as, for example, “0” indicating “without stacking” and “1” indicating “with stacking”. Note that, in the case of being stacked in a plurality of stages, for example, in the case of being stacked in three stages, it may be represented as “2” indicating “with stacking”. The product image is an image of the product as illustrated in FIG. 11.

The model storage unit 35 stores models learned for each of the shape of the product shelf, the shape of the product, the stacked state of the products, and the condition of the display. The model storage unit includes a first model storage unit 35a and a second model storage unit 35b.

For a certain product, the first model storage unit 35a stores a model (first model) that has learned a difference (first difference) between a displayable region in which products on a shelf stand included in a first image captured at a first time are allowed to be displayed and a displayable region of the shelf stand included in a second image captured at the second time after the first time.

The second model storage unit 35b stores the second model and the conversion table. For a certain product, the second model is a model that has learned association between the first difference and a second difference between the number of products appearing in the first image and the number of products appearing in the second image. Specifically, for a certain product, the second model is a model that estimates the displayable region and the number products based on the first difference and a second difference that is a difference between the number of products appearing in the first image and the number of products appearing in the second image. The second model outputs a conversion table as a result of estimating the displayable region and the number of products. The conversion table is a table in which a change in the area of a certain product is associated with a change in the number of products. The conversion table may be updated as the detection accuracy of the second model is improved. By creating and updating the conversion table in this manner, the calculation speed of the second model can be increased.

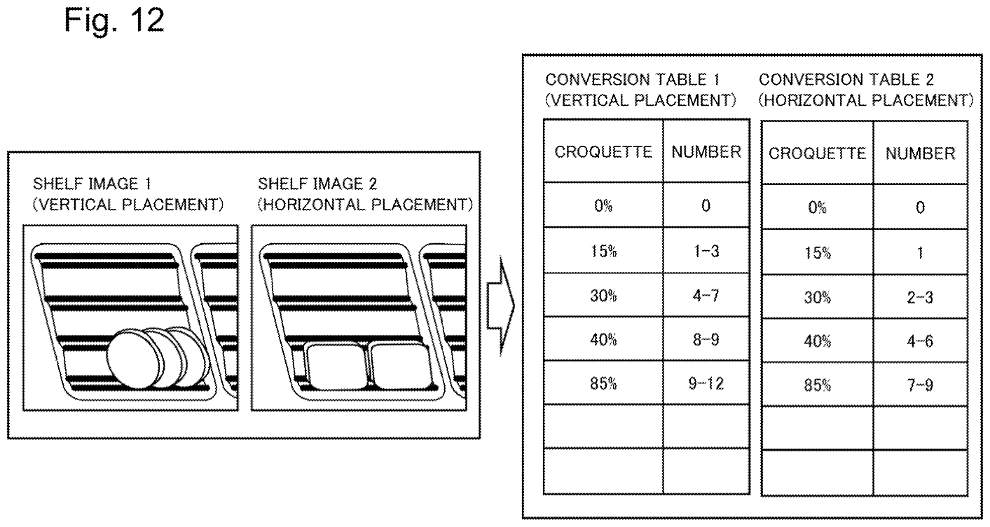

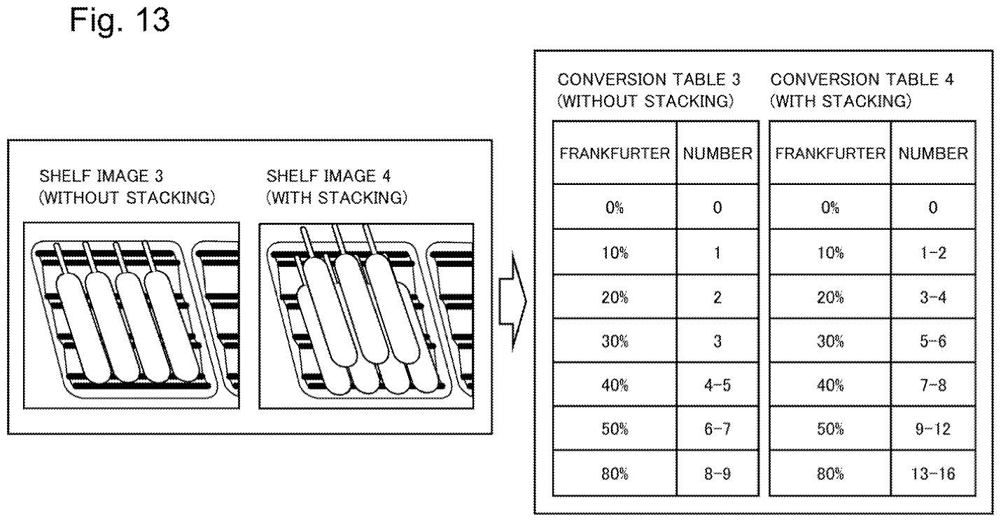

An example of the conversion table will be described with reference to FIGS. 12 and 13. In the conversion tables 1 to 4 of FIGS. 12 and 13, the left column indicates the area ratio, and the right column indicates the number. The area ratio is a ratio of an area occupied by the product image to that of the shelf image. The number is a number indicating the number of products included in the shelf image. For example, in the case of “the area ratio is 15%, the number is 1 to 3” in the first row from the top of the conversion table 1 (see FIG. 12), the area ratio of the product image to the shelf image is 15%, and the number of products appearing in the shelf image is detected (estimated) to be 1 to 3. The conversion table is updated as the detection accuracy of the second model is improved.

The left figure in FIG. 12 illustrates a shelf image 1 in which product croquettes are vertically placed and a shelf image 2 in which product croquettes are horizontally placed in a product shelf (hot showcase). The right figure in FIG. 12 illustrates the conversion table 1 that is a result of detection of the products and the number of products from the shelf image 1 by the first and second models, and the conversion table 2 that is a result of detection of the products and the number of products from the shelf image 2 by the first and second models.

The left figure in FIG. 13 illustrates the shelf image 3 in which the product frankfurters are placed flat without being stacked and the shelf image 4 in which the product frankfurters are placed in a stacking manner in the product shelf (hot showcase). The right figure in FIG. 13 illustrates a conversion table 3 that is a result of detection of the products and the number of products from a shelf image 3 by the first and second models, and a conversion table 4 that is a result of detection of the products and the number of products from a shelf image 4 by the first and second models.

The determination unit 36 determines product display information including at least one of a shape of the shelf, a shape of the product (including a stacked state of products), or a condition of the display from an image captured for detection by the camera 3. The determination is made by using, for example, an image recognition engine (a pattern recognition model such as a support vector machine) by machine learning.

The determination unit 36 compares the image of the product in the image with the product information (see FIG. 11) stored in the product information storage unit 34 to determine the shape of the product.

The selection unit 37 selects a model to be used for image detection based on the product display information (information including at least one of a shape of the shelf, a shape of the product (including a stacked state of products), or a condition of the display) determined by the determination unit 36. For example, assuming that the shape of the product shelf has a 3 patterns, the shape of the product has a 3 patterns, the stacked state of the product has a 2 patterns, and the condition of the display has a 2 patterns, 36 types of region estimation models and conversion tables are stored in the model storage unit 35.

The selection unit 37 includes a first model selection unit 37a and a second model selection unit 37b. The first model selection unit 37a selects the first model matching the result of the determination by the determination unit 36 from the first model storage unit 35a. The second model selection unit 37b selects the second model matching the result of the determination by the determination unit 36 from the second model storage unit 35b. The first model selection unit 37a and the second model selection unit 37b notify the detection unit 18 of the selected first model and second model.

### (Operation of Product Detection Device)

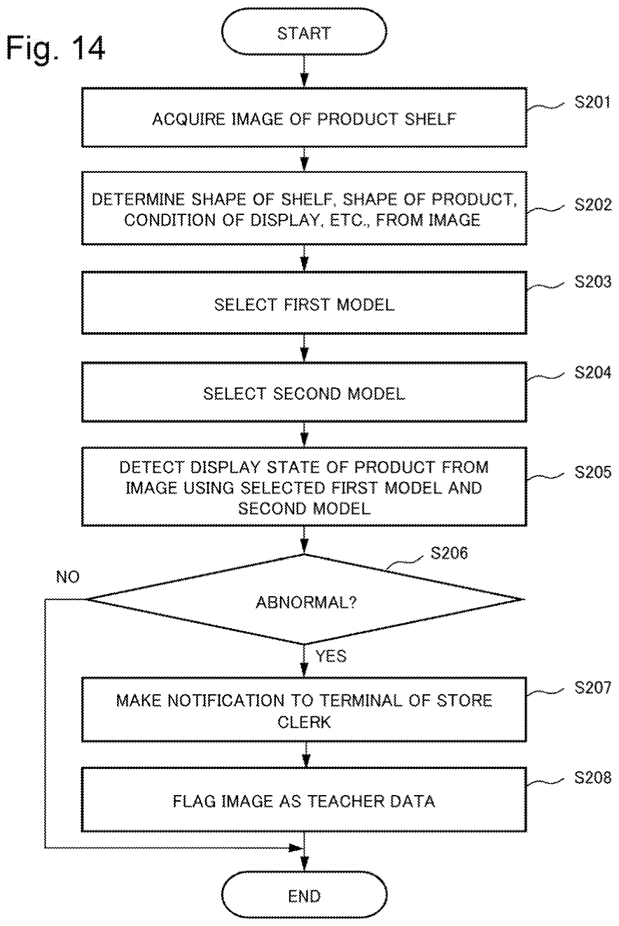

An operation of the product detection device lain the product detection system 200 will be described with reference to a flowchart illustrated in FIG. 14. As a premise, the shelf information is stored in the shelf information storage unit 13, the product information is stored in the product information storage unit 34, and a model is stored in the model storage unit 35.

First, in step S201, the image acquisition unit 11 acquires a shelf image, which is one section of the product shelf imaged by the camera 3, to store the shelf image in the image storage unit 12. Specifically, the image acquisition unit 11 generates image information about the shelf image, and stores the shelf image and the generated image information in association with each other in the image storage unit 12.

In step S202, the determination unit 36 determines, from the shelf image, the product display information including at least one of the shape of the shelf, the shape of the product (including a stacked state of products), or the condition of the display. Specifically, the determination unit 36 acquires the shelf image from the image storage unit 12, and determines the shape of the shelf included in the shelf image, the shape of the product included in the shelf image, the stacked state of the products, and the condition of the display of the product. The determination unit 36 transmits the determined information to the selection unit 37.

In step S203, the selection unit 37 selects a model to be used for detecting the shelf image based on the product display information determined by the determination unit 36. Specifically, the first model selection unit 37a selects the first model matching the result of the determination by the determination unit 36 from the first model storage unit 35a. In step S204, the second model selection unit 37b selects the second model matching the result of the determination by the determination unit 36 from the second model storage unit 35b. The first model selection unit 37a and the second model selection unit 37b notify the detection unit 18 of the selected first model and second model.

In step S205, the detection unit 18 detects the display state of the product on the shelf from the shelf image using the model (first model, second model) selected by the selection unit 37. Specifically, the detection unit 18 detects an anomaly (for example, product stockout, display disturbance) in the display of the product included in the shelf image by using the model. When an anomaly is detected (YES in step S206), the detection unit 18 transmits a detection result (for example, the occurrence of product stockout and the occurrence of display disturbance) to the notification unit 19, and the process proceeds to step S207. When no anomaly is detected (NO in step S206), this process ends.

In step S207, the notification unit 19 transmits the detection result to the store terminal 2.

In step S208, the notification unit 19 flags the shelf image in the image storage unit 12. This is because the shelf image in which the anomaly is detected can be extracted later. The notification unit 19 may add an index to the shelf image in the image storage unit 12. The flagged shelf image is used as teacher data for causing the model to relearn (feed back).

Thus, the operation of the product detection device 1a in the product detection system 200 is ended.

### Effects of Second Example Embodiment

According to the second example embodiment of the present disclosure, it is possible to further improve detection accuracy by using a model suitable for a display state in a store, compared with the first example embodiment. This is because the image acquisition unit 11 acquires an image of a shelf on which a product is displayed, the determination unit 36 determines product display information including at least one of a shape of the shelf, a shape of the product (including a stacked state of the product), or a condition of the display, the selection unit 17 selects a model to be used for detecting the image based on the determined product display information, and the detection unit 18 detects a display state of the product displayed on the shelf from the image using the selected model. Specifically, this is because the determination unit 36 determines the shape of the product based on information including the stacked state of the products (the shape of the product placed on one stage or the shape of the products placed on a plurality of stages in a stacking manner).

### Third Example Embodiment

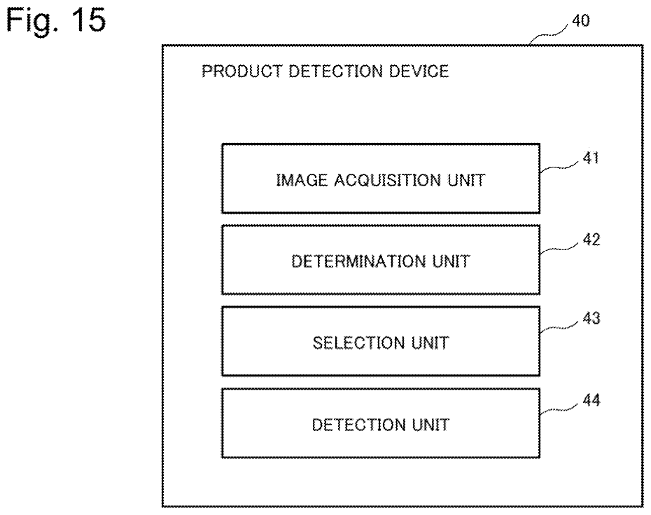

A product detection device 40 according to the third example embodiment of the present disclosure will be described with reference to FIG. 15. The product detection device 40 is a minimum configuration mode of the first example embodiment and the second example embodiment. A product detection device 40 includes an image acquisition unit 41, a determination unit 42, a selection unit 43, and a detection unit 44.

The image acquisition unit 41 acquires an image of a shelf on which products are displayed. The determination unit 42 determines, from the image, product display information including at least one of a shape of the shelf, a shape of the product, and a condition of the display. The selection unit 43 selects, based on the determined product display information, a model to be used to detect the image. The detection unit 44 uses the selected model to detect the state of the display of the products displayed on the shelf from the image.

According to the third example embodiment of the present disclosure, it is possible to improve detection accuracy by using a model suitable for a display state in a store. This is because the image acquisition unit 41 acquires an image of a shelf on which a product is displayed, the determination unit 42 determines product display information including at least one of a shape of the shelf, a shape of the product, or a condition of the display, the selection unit 43 selects a model to be used for detecting the image based on the determined product display information, and the detection unit 44 detects a display state of the product displayed on the shelf from the image using the selected model.

### <Hardware Configuration>

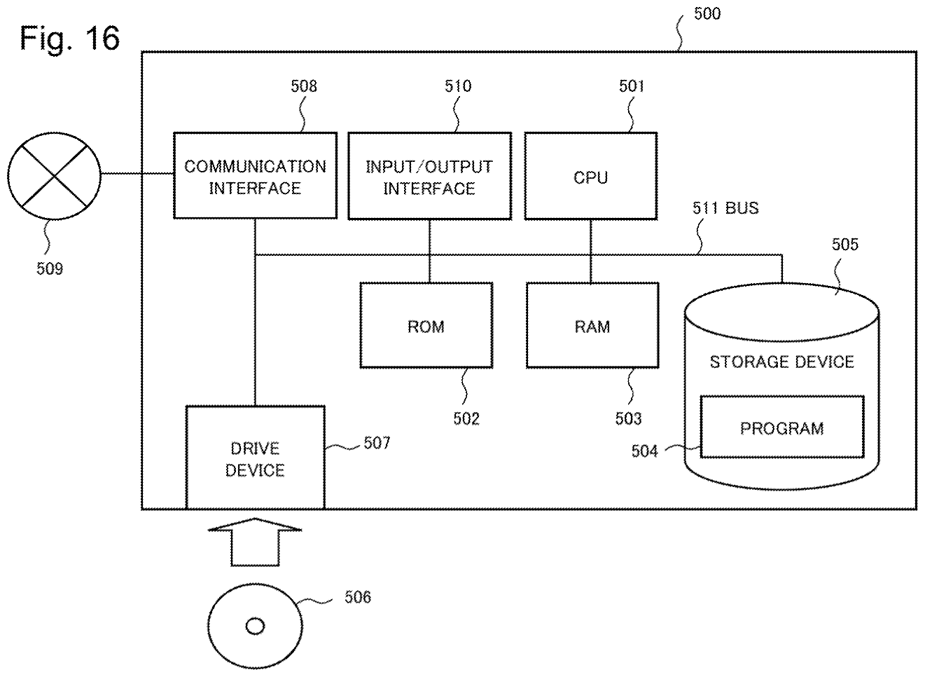

In the example embodiments of the present disclosure, each component of each device (product detection device 1, 1a, 40, and the like) included in each of product detection systems 100, 200 indicates a block of a functional unit. A part or all of each component of each device is achieved by, for example, any combination of an information processing device (computer) 500 and a program as illustrated in FIG. 16. The information processing device 500 includes the following configuration as an example.
CPU (Central Processing Unit) 501
ROM (Read Only Memory) 502
RAM (Random Access Memory) 503
Program 504 loaded into RAM 503
Storage device 505 storing program 504
Drive device 507 that reads and writes recording medium 506
Communication interface 508 connected with a communication network 509
Input/output interface 510 for inputting/outputting data
Bus 511 connecting each component

Each component of each device in each example embodiment is achieved by the CPU 501 acquiring and executing the program 504 for implementing these functions. The program 504 for implementing the function of each component of each device is stored in the storage device 505 or the RAM 503 in advance, for example, and is read by the CPU 501 as necessary. The program 504 may be supplied to the CPU 501 via the communication network 509, or may be stored in advance in the recording medium 506, and the drive device 507 may read the program and supply the program to the CPU 501.

There are various modifications of the implementation method of each device. For example, each device may be achieved by any combination of the information processing device 500 and the program separate for each component. A plurality of components included in each device may be achieved by any combination of one information processing device 500 and a program.

Part or all of each component of each device is achieved by another general-purpose or dedicated circuit, processor, or the like, or a combination thereof. These may be configured by a single chip or may be configured by a plurality of chips connected via a bus.

Part or all of each component of each device may be achieved by a combination of the above-described circuit or the like and a program.

In a case where part or all of each component of each device and the like are achieved by a plurality of information processing devices, circuits, and the like, the plurality of information processing devices, circuits, and the like may be disposed in a centralized manner or in a distributed manner. For example, the information processing device, the circuit, and the like may be achieved as a form in which each of the information processing device, the circuit, and the like is connected via a communication network, such as a client and server system, a cloud computing system, and the like.

Some or all of the above example embodiments may be described as the following Supplementary Notes, but are not limited to the following.

### [Supplementary Note 1]

A product detection device including
an image acquisition unit that acquires an image of a shelf on which a product is displayed,
a determination unit that determines, from the image, product display information including at least one of a shape of the shelf, a shape of the product, or a condition of the display,
a selection unit that selects a model to be used for detecting the image based on the determined product display information, and
a detection unit that detects, from the image, a display state of the product displayed on the shelf by using the selected model.

### [Supplementary Note 2]

The product detection device according to Supplementary Note 1, further including
a model storage unit that stores the one or more models learned for detecting the product from the image, the models related to the product display information, wherein
the selection unit selects the model matching the product display information from the model storage unit.

### [Supplementary Note 3]

The product detection device according to Supplementary Note 1 or 2, wherein
the shape of the product includes a shape of the product imaged from a plurality of angles.

### [Supplementary Note 4]

The product detection device according to any one of Supplementary Notes 1 to 3, wherein
the shape of the product includes a shape of the product placed on one stage and a shape of the products placed on a plurality of stages in a stacking manner.

### [Supplementary Note 5]

The product detection device according to Supplementary Note 1 or 2, wherein
the model
includes a first model, for a certain product, in which a first difference between a displayable region, in a first image of a shelf on which the product is displayed, in which the product is allowed to be displayed and the displayable region in a second image acquired after acquisition of the first image is learned.

### [Supplementary Note 6]

The product detection device according to Supplementary Note 5, wherein
the model
includes a second model, for the certain product, in which association between the first difference and a second difference between the number of the products appearing in the first image and the number of the products appearing in the second image is learned.

### [Supplementary Note 7]

The product detection device according to Supplementary Note 1, further including
a notification unit that notifies an external terminal of a result of the detection when an anomaly in a display state of the product is detected by the detection unit.

### [Supplementary Note 8]

A product detection system including
the product detection device according to any one of Supplementary Notes 1 to 7,
a camera that captures the image to transmit the image to the product detection device, and
a terminal that receives a notification related to the detection from the product detection device.

### [Supplementary Note 9]

A product detection method including
acquiring an image of a shelf on which a product is displayed,
determining, from the image, product display information including at least one of a shape of the shelf, a shape of the product, or a condition of the display,
selecting a model to be used for detecting the image based on the determined product display information, and
detecting, from the image, a display state of the product displayed on the shelf by using the selected model.

### [Supplementary Note 10]

The product detection method according to Supplementary Note 9, wherein
the selecting includes selecting the model matching the product display information from a model storage means configured to store the one or more models learned for detecting the product from the image, the models related to the product display information.

### [Supplementary Note 11]

The product detection method according to Supplementary Note 9 or 10, wherein
the shape of the product includes a shape of the product imaged from a plurality of angles.

### [Supplementary Note 12]

The product detection method according to any one of Supplementary Notes 9 to 11, wherein
the shape of the product includes a shape of the product placed on one stage and a shape of the products placed on a plurality of stages in a stacking manner.

### [Supplementary Note 13]

The product detection method according to Supplementary Note 9 or 10, wherein
the model
includes a first model, for a certain product, in which a first difference between a displayable region, in a first image of a shelf on which the product is displayed, in which the product is allowed to be displayed and the displayable region in a second image acquired after acquisition of the first image is learned.

### [Supplementary Note 14]

The product detection method according to Supplementary Note 13, wherein
the model
includes a second model, for the certain product, in which association between the first difference and a second difference between the number of the products appearing in the first image and the number of the products appearing in the second image is learned.

### [Supplementary Note 15]

The product detection method according to Supplementary Note 9, further including
notifying an external terminal of a result of the detection when an anomaly in a display state of the product is detected in the detecting.

### [Supplementary Note 16]

A recording medium storing a product detection program that causes a computer to execute
acquiring an image of a shelf on which a product is displayed,
determining, from the image, product display information including at least one of a shape of the shelf, a shape of the product, or a condition of the display,
selecting a model to be used for detecting the image based on the determined product display information, and
detecting, from the image, a display state of the product displayed on the shelf by using the selected model.

### [Supplementary Note 17]

The recording medium according to Supplementary Note 16, wherein
the selecting includes selecting the model matching the product display information from a model storage means configured to store the one or more models learned for detecting the product from the image, the models related to the product display information.

### [Supplementary Note 18]

The recording medium according to Supplementary Note 16 or 17, wherein
the shape of the product includes a shape of the product imaged from a plurality of angles.

### [Supplementary Note 19]

The recording medium according to any one of Supplementary Notes 16 to 18, wherein
the shape of the product includes a shape of the product placed on one stage and a shape of the products placed on a plurality of stages in a stacking manner.

### [Supplementary Note 20]

The recording medium according to Supplementary Note 16 or 17, wherein
the model
includes a first model, for a certain product, in which a first difference between a displayable region, in a first image of a shelf on which the product is displayed, in which the product is allowed to be displayed and the displayable region in a second image acquired after acquisition of the first image is learned.

### [Supplementary Note 21]

The recording medium according to Supplementary Note 20, wherein
the model
includes a second model, for the certain product, in which association between the first difference and a second difference between the number of the products appearing in the first image and the number of the products appearing in the second image is learned.

### [Supplementary Note 22]

The recording medium according to Supplementary Note 16, the executing further including
notifying an external terminal of a result of the detection when an anomaly in a display state of the product is detected in the detecting.

While the invention has been particularly shown and described with reference to the example embodiments and the examples, the invention is not limited to the example embodiments and the examples. It will be understood by those of ordinary skill in the art that various changes in form and details may be made therein without departing from the spirit and scope of the present invention as defined by the claims.

### REFERENCE SIGNS LIST

1 product detection device
1a product detection device
2 store terminal
3 camera
4 communication network
11 image acquisition unit
12 image storage unit
13 shelf information storage unit
14 product information storage unit
15 model storage unit
16 determination unit
17 selection unit
18 detection unit
19 notification unit
21 reading unit
22 communication unit
23 output unit
24 input unit
25 control unit
34 product information storage unit
35 model storage unit
35a first model storage unit
35b second model storage unit
36 determination unit
37 selection unit
37a first model selection unit
37b second model selection unit
40 product detection device
41 image acquisition unit
42 determination unit
43 selection unit
44 detection unit
100 product detection system
200 product detection system
500 information processing device
501 CPU
502 ROM
503 RAM
504 program
505 storage device
506 recording medium
507 drive device
508 communication interface
509 communication network
510 input/output interface
511 bus

What is claimed is:

1. A product detection device comprising:
one or more memories storing instructions; and
one or more processors configured to execute the instructions to:
acquire an image of a shelf on which a product is displayed;
determine, from the image, product display information including at least one of a shape of the shelf, a shape of the product, or a condition of a display of the product;
select a model to be used for detecting the image based on the determined product display information; and
detect, from the image, a display state of the product displayed on the shelf by using the selected model.

2. The product detection device according to claim 1,
wherein the one or more memories store one or more models learned for detecting the product from the image, the one or more models related to the product display information,
and wherein the one or more processors configured to execute the instructions to:
select the model matching the product display information from the one or more memories.

3. The product detection device according to claim 1, wherein
the shape of the product includes a shape of the product imaged from a plurality of angles.

4. The product detection device according to claim 1, wherein
the shape of the product includes a shape of the product placed on one stage and a shape of the products placed on a plurality of stages in a stacking manner.

5. The product detection device according to claim 1, wherein
the one or more models includes a first model, for a certain product, in which a first difference between a displayable region, in a first image of a shelf on which the product is displayed, in which the product is allowed to be displayed and the displayable region in a second image acquired after acquisition of the first image is learned.

6. The product detection device according to claim 5, wherein
the one or more models includes a second model, for the certain product, in which association between the first difference and a second difference between the number of the products appearing in the first image and the number of the products appearing in the second image is learned.

7. The product detection device according to claim 1, wherein the one or more processors configured to execute the instructions to:
notify an external terminal of a result of the detection when an anomaly in a display state of the product is detected.

8. (canceled)

9. A product detection method comprising:
acquiring an image of a shelf on which a product is displayed;
determining, from the image, product display information including at least one of a shape of the shelf, a shape of the product, or a condition of a display of the product;
selecting a model to be used for detecting the image based on the determined product display information; and
detecting, from the image, a display state of the product displayed on the shelf by using the selected model.

10. The product detection method according to claim 9, wherein
the selecting includes selecting the model matching the product display information from a one or more memories storing one or more models learned for detecting the product from the image, the one or more models related to the product display information.

11. The product detection method according to claim 9, wherein
the shape of the product includes a shape of the product imaged from a plurality of angles.

12. The product detection method according to claim 9, wherein
the shape of the product includes a shape of the product placed on one stage and a shape of the products placed on a plurality of stages in a stacking manner.

13. The product detection method according to claim 9, wherein
the one or more models includes a first model, for a certain product, in which a first difference between a displayable region, in a first image of a shelf on which the product is displayed, in which the product is allowed to be displayed and the displayable region in a second image acquired after acquisition of the first image is learned.

14. The product detection method according to claim 13, wherein
the one or more models includes a second model, for the certain product, in which association between the first difference and a second difference between the number of the products appearing in the first image and the number of the products appearing in the second image is learned.

15. The product detection method according to claim 9, further comprising:
notifying an external terminal of a result of the detecting when an anomaly in a display state of the product is detected in the detecting.

16. A recording medium storing a product detection program that causes a computer to execute:
acquiring an image of a shelf on which a product is displayed;
determining, from the image, product display information including at least one of a shape of the shelf, a shape of the product, or a condition of a display of the product;
selecting a model to be used for detecting the image based on the determined product display information; and
detecting, from the image, a display state of the product displayed on the shelf by using the selected model.

17.-22. (canceled)

23. The product detection device according to claim 2, wherein
the shape of the product includes a shape of the product imaged from a plurality of angles.

24. The product detection device according to claim 23, wherein
the shape of the product includes a shape of the product placed on one stage and a shape of the products placed on a plurality of stages in a stacking manner.

25. The product detection device according to claim 24, wherein
the one or more models includes a first model, for a certain product, in which a first difference between a displayable region, in a first image of a shelf on which the product is displayed, in which the product is allowed to be displayed and the displayable region in a second image acquired after acquisition of the first image is learned.

26. The product detection device according to claim 25, wherein
the one or more models includes a second model, for the certain product, in which association between the first difference and a second difference between the number of the products appearing in the first image and the number of the products appearing in the second image is learned.

27. The product detection device according to claim 26, wherein the one or more processors configured to execute the instructions to:
notify an external terminal of a result of the detection when an anomaly in a display state of the product is detected.
